(19) United States
(12) Patent Application Publication
(10) Pub. No.: US 2014/0377451 A1
(43) Pub. Date: Dec. 25, 2014

(54) ACTIVE MATERIAL-COATING APPARATUS FOR BATTERY AND METHOD OF OPERATING THE SAME

(71) Applicant: SAMSUNG SDI CO., LTD., Yongin-si (KR)

(72) Inventors: Tae-Sung Kim, Yongin-si (KR); Ho-Seob Lee, Yongin-si (KR); Woong-Sik Ham, Yongin-si (KR); Jee-Sang Hwang, Yongin-si (KR)

(73) Assignee: SAMSUNG SDI CO., LTD., Yongin-si (KR)

(21) Appl. No.: 14/089,682

(22) Filed: Nov. 25, 2013

(30) Foreign Application Priority Data
Jun. 21, 2013 (KR) 10-2013-0071950

(51) Int. Cl. H01M 4/04

(52) U.S. Cl. CPC H01M 4/0419
USPC 427/58; 118/302; 118/712

(57) ABSTRACT

Provided is an active material-coating apparatus for a secondary battery and methods of operating the same. The active material-coating apparatus includes a tank having an active material, a pump coupled to the tank such that the active material is routed through the pump, a temperature control unit coupled to the pump and configured to control heating or cooling of a temperature of the active material routed through the pump. The temperature control unit may include a control unit configured to control a temperature of the temperature control unit. The active material-coating apparatus may further include a coating unit coupled to the temperature control unit, and a reel including a current collector, the reel being configured to route the current collector through the coating unit such that the current collector is coated with the active material routed through the temperature control unit and ejected from the coating unit.

### CROSS-REFERENCE TO RELATED APPLICATION

This application claims priority to and the benefit of Korean Patent Application No. 10-2013-0071950, filed on Jun. 21, 2013, in the Korean Intellectual Property Office, the disclosure of which is incorporated herein in its entirety by reference.

### BACKGROUND

1. Field

One or more embodiments of the present invention relate to active material-coating apparatuses for batteries and methods of operating the same.

2. Description of the Related Art

Unlike a primary battery that is not rechargeable, a secondary battery can be discharged and recharged. Secondary batteries are widely used as energy sources for mobile electronic devices, such as digital cameras, cellular phones, and computers.

Secondary batteries are also used, in an effort to solve environmental problems, as an energy source for hybrid electrical vehicles as an alternative to conventional gasoline and diesel internal engines that use fossil fuels. Further, secondary batteries are also often used as household or industrial energy storing systems.

A secondary battery includes an electrode assembly having a positive electrode plate, a negative electrode plate, and a separator interposed between the positive electrode plate and negative electrode plate. The positive and negative electrode plates are formed by coating an active material on a conductive metal plate. During coating of the active material on the conductive metal plate, often a filament phenomenon and/or a falling-spot phenomenon causing an unclear boundary may occur. The filament phenomenon occurs when the active material spreads towards areas of the conductive metal plate where no coating should be placed. The falling-spot phenomenon occurs when the active material is coated in a spotted or dotted pattern on a region of the conductive metal plate where no coating should be placed. Often the occurrence of the filament phenomenon and/or falling-spot phenomenon is related to increased coating velocities. Other issues such as a non-uniform thickness of the active material coating on the conductive metal plate, and/or a deviation of the loading level on the conductive metal plate may also occur.

### SUMMARY

One or more embodiments of the present invention relate to an active material-coating apparatus for a battery and methods of operating the same.

Additional aspects of embodiments of the present invention will be set forth in part in the description which follows and, in part, will be apparent from the description, or may be learned by practice of the presented embodiments of the present invention.

According to one or more embodiments of the present invention, there is provided an active material-coating apparatus for a secondary battery, the active material-coating apparatus including a tank having an active material, a pump coupled to the tank such that the active material is routed through the pump, a temperature control unit coupled to the pump, the temperature control unit configured to control heating or cooling of a temperature of the active material routed through the pump and including a control unit, the control unit configured to control a temperature of the temperature control unit, a coating unit coupled to the temperature control unit, and a reel including a current collector, wherein the reel is configured to route the current collector through the coating unit such that the current collector is coated with the active material routed through the temperature control unit and ejected from the coating unit.

The coating unit of the active material-coating apparatus may further include a heat insulating unit and an ejection unit, wherein the heat insulating unit is configured to maintain the temperature of the active material that is ejected through the ejection unit at a constant temperature.

The control unit of the active material-coating apparatus may be configured to control the temperature control unit and the heat insulating unit such that the temperature of the active material heated or cooled by the temperature control unit is greater than a constant temperature of the active material that is maintained by the heat insulating unit.

The control unit of the active material-coating apparatus may be configured control the temperature control unit such that the active material ejected through the coating unit is able to be maintained at a temperature from about 30° C. to about 50° C.

The control unit of the active material-coating apparatus may control the temperature control unit such that the active material ejected through the coating unit is maintained at a temperature from about 35° C. to about 45° C.

The temperature control unit of the active material-coating apparatus may include an inlet and an outlet, and the control unit may include inlet and outlet temperature sensors provided on the inlet and the outlet of the temperature control unit, respectively, and may be configured to control the temperature control unit based on the temperatures measured by the inlet and outlet temperature sensors.

The active material-coating apparatus may further include a valve that is coupled between the temperature control unit and the coating unit, the valve may be configured to control the active material routed to the coating unit.

The valve of the active material-coating apparatus may include a first supply tube coupling the valve with the coating unit such that the valve may supply a portion of the active material to the coating unit through the first supply tube, and the valve may also include a second supply tube coupling the valve with the tank such that the valve may supply a remaining portion of the active material not supplied to the coating unit to the tank through the second supply tube.

The coating unit of the active material-coating apparatus may include an ejection unit having a slit shape.

A length of the ejection unit of the active material-coating apparatus may be smaller than a width of the reel such that the active material is coated onto a region of the current collector routed by the reel.

The active material-coating apparatus may further include a heat insulating unit surrounding the coating unit and centered around the ejection unit.

The active material-coating apparatus may further include a filter coupled between the pump and the temperature control unit and configured to remove impurities in the active material.

The temperature control unit of the active material-coating apparatus may be a thermoelectric device, and the control unit may be configured to control heating or cooling of the temperature control unit by controlling a current that is supplied to the thermoelectric device.

The temperature control unit of the active material-coating apparatus may be a thermoacoustic device, and the control unit may be configured to control heating or cooling of the temperature control unit by controlling a thermoacoustic wave.

The temperature control unit of the active material-coating apparatus may be a heat exchanger for warm water and cool water, and the control unit may be configured to control heating or cooling of the temperature control unit by controlling a flow of warm water or cool water into the heat exchanger.

According to one or more embodiments of the present invention, there is provided a method of operating an active material-coating apparatus, the method including supplying an active material stored in a tank to a temperature control unit through a pump; controlling a temperature of the active material supplied to the temperature control unit by cooling or heating the active material using the temperature control unit to a first temperature; supplying the active material at the first temperature from the temperature control unit to a coating unit; maintaining the active material at a constant temperature using a heat insulating unit surrounding the coating unit such that the active material ejected through the coating unit has a second temperature; and coating the active material having the second temperature onto an electrode assembly supplied through the coating unit, wherein the first temperature is higher than the second temperature.

In an embodiment, the second temperature of the active material is maintained constant from about 30° C. to about 50° C.

The temperature control unit of the active material-coating apparatus may include an inlet and an outlet, and controlling the temperature of the active material may include determining cooling or heating of the temperature control unit based on a temperature measured at the inlet of the temperature control unit and a temperature measured at the outlet of the temperature control unit.

Supplying the active material to the coating unit may further include supplying a portion of the active material to the coating unit; and supplying the remaining portion of the active material not supplied to the coating unit back to the tank.

The method may further include removing impurities in the active material using a filter.

The active material-coating apparatus according to current embodiments of the present application minimizes filament and falling spot-distances, increases coating velocity, and forms an active material coating on the current collector with a uniform thickness, minimizing deviation of its loading level.

### BRIEF DESCRIPTION OF THE DRAWINGS

These and/or other aspects of embodiments of the present invention will become apparent and more readily appreciated from the following description of the embodiments, taken in conjunction with the accompanying drawings, in which:

FIG. 1 is a schematic block diagram of an active material-coating apparatus for a battery, according to an embodiment of the present invention;

FIG. 2 is a cross-sectional view of a temperature control unit of FIG. 1;

FIG. 3 is a perspective view of a coating unit and a reel unit of FIG. 1;

FIG. 4 is a photo image showing an example of an active material coated onto a current collector according to an embodiment of the present invention;

FIG. 5 is a graph illustrating the correlation between distances of falling-spots generated from a coating region of a coated current collector as the temperature of the active material is increased;

FIG. 6A is a schematic plan view of an ejection unit formed on a coating unit according to an embodiment of the present invention, and FIG. 6B is a schematic elevation view of an upper surface of an electrode plate on which the active material ejected through the ejection unit of 6A is coated, according to an embodiment of the present invention; and

FIGS. 7A through 7C are graphs illustrating the thicknesses of an active material coated onto a current collector using the coating unit and the reel shown in FIG. 3 compared with a width of the current collector along a length direction of a slot, according to an embodiment of the present invention. FIG. 7A shows the thickness of the active material when the temperature of the active material ejected from the ejection unit is 30° C., FIG. 7B shows the thickness of the active material when the temperature of the active material ejected from the ejection unit is 40° C., and FIG. 7C shows the thickness of the active material when the temperature of the active material ejected from the ejection unit is 50° C.

### DETAILED DESCRIPTION

Reference will now be made in detail to embodiments, examples of which are illustrated in the accompanying drawings, wherein like reference numerals refer to the like elements throughout. While exemplary embodiments are capable of various modifications and alternative forms, embodiments herein are shown by way of example in the drawings and should not be construed as being limited to the descriptions set forth herein. The embodiments will herein be described in detail. It should be understood, however, that there is no intent to limit embodiments of the present invention to the particular forms disclosed, but on the contrary, these embodiments are to cover all modifications, equivalents, and alternatives falling within the scope and spirit of the invention. In describing the embodiments of the present invention, when practical descriptions with respect to related known functions and configurations may unnecessarily make the scope of the present invention unclear, the descriptions thereof will be omitted. It will be understood that, although the terms “first”, “second”, etc., may be used herein to describe various elements, these elements should not be limited by these terms. These terms are only used to distinguish one element from another. The terminologies used herein are for the purpose of describing embodiments only and are not intended to be limiting of exemplary embodiments. As used herein, the singular forms “a”, “an”, and “the” are intended to include the plural forms as well, unless the context clearly indicates otherwise. It will be further understood that the terms “comprises”, “comprising”, “includes”, and/or “including” when used herein, specify the presence of stated features, integers, steps, operations, elements, and/or components, but do not preclude the presence or addition of one or more other features, integers, steps, operations, elements, components, and/or groups thereof. Meanwhile, the symbol “/” may be interpreted as “and” or “or” according to the context in which it is presented.

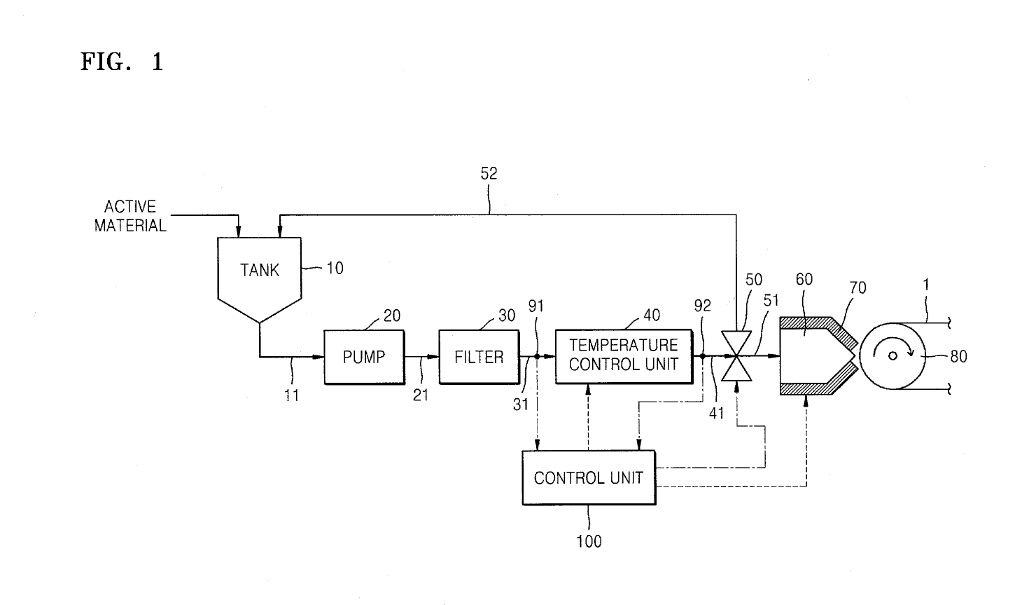

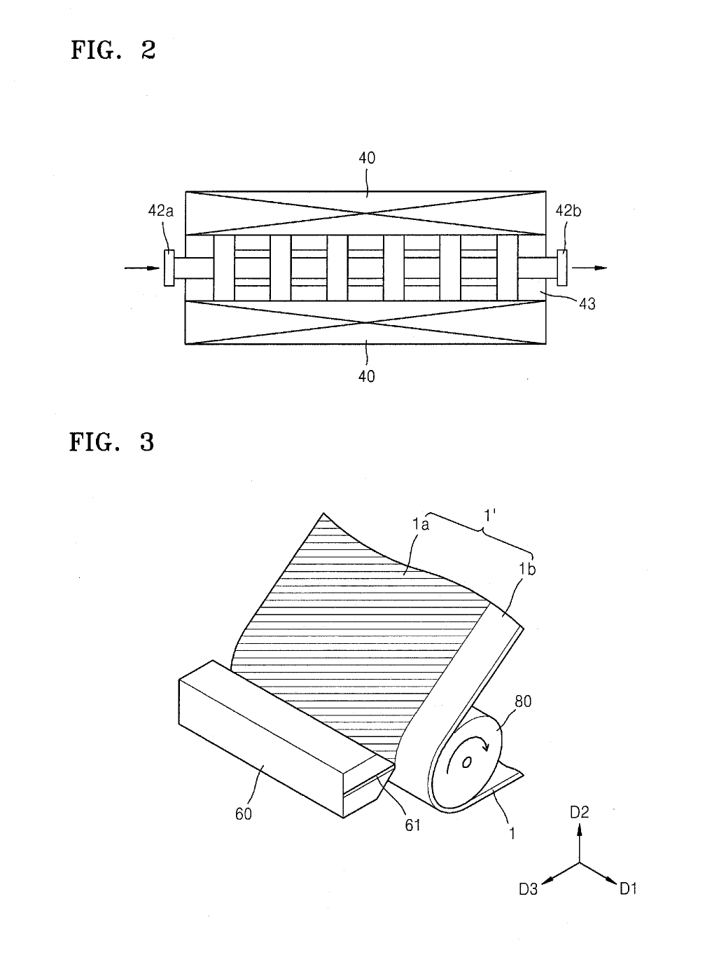

FIG. 1 is a schematic block diagram of an active material-coating apparatus for a battery, according to an embodiment of the present invention. FIG. 2 is a cross-sectional view of a temperature control unit of FIG. 1.

Referring to FIG. 1, the active material-coating apparatus according to an embodiment of the present invention is used for a secondary battery, and includes a reel 80 that supplies a current collector 1 for coating, a tank 10 where an active material is stored, a pump 20, a filter 30, a temperature control unit 40 that cools or heats the active material, a coating unit 60 that coats the active material onto the current collector 1, a heat insulating unit 70 that surrounds the coating unit 60, and a control unit 100.

In this embodiment, the active material stored in the tank 10 flows toward the temperature control unit 40 through tubes 11, 21, and 31, respectively passing through the pump 20, the filter 30, and the temperature control unit 40. In this embodiment, the active material passing the temperature control unit 40 then flows toward the coating unit 60 through a supply tube 41 and a first supply tube 51. Subsequently, the active material is coated onto the current collector 1 supplied by the reel 80 using the coating unit 60, as illustrated in the embodiment shown in FIG. 1. The active material stored in the tank 10 may be a positive active material or a negative active material.

An electrode assembly included in a secondary battery includes a positive electrode plate, a negative electrode plate, and a separator interposed between the positive and negative electrode plates. The positive and negative electrode plates are each formed according to an embodiment, by coating an active material onto the current collector 1, with the polarity of the positive and negative electrode plates varying according to the type of active material used.

For example, the positive electrode plate may be formed by coating a positive active material on a surface of a positive current collector 1 that is formed of, for example, aluminum, and allowing the coating to dry. In this embodiment, positive active material is stored in the tank 10 and is supplied to the coating unit 60. The positive active material may be a lithium containing transition metal oxide, such as LiCoO₂, LiNiO₂, LiMnO₂, or LiMnO₄, or a lithium chalcogenide compound, but the embodiments of the present invention are not limited thereto.

In another embodiment, the negative electrode plate may be formed by coating a negative active material on a surface of a negative current collector 1 that is formed of, for example, copper, and allowing the coating to dry. In this embodiment, the negative active material is stored in the tank 10 and is supplied to the coating unit 60. The negative active material may be, for example, a carbon material, such as crystalline carbon, amorphous carbon, carbon complex, or carbon fiber; a lithium metal;

or a lithium alloy, but the embodiments of the present invention are not limited thereto.

In the embodiment shown in FIG. 1, the active material stored in the tank 10 is supplied to the temperature control unit 40 by the pump 20. The filter 30 may be located between the pump 20 and the temperature control unit 40. In this embodiment, the filter 30 removes impurities included in the active material. Alternatively, if the impurities are removed from the active material before it is stored in the tank 10, the filter 30 may be omitted from a moving path of the active material from the pump 20 to the temperature control unit 40.

As shown in the embodiment in FIG. 1, the active material that passes the filter 30 flows into the temperature control unit 40. The temperature control unit 40 may cool or heat the active material supplied to it.

In the embodiment shown in FIG. 1, the temperature control unit 40 controls the temperature of the active material to ensure the coating quality of the active material to be ejected through the coating unit 60. As depicted in the embodiment shown in FIG. 2, the temperature control unit 40 is formed around an inner tube 43 that includes an inlet 42a and an outlet 42b to control the temperature of the active material that flows through the inner tube 43. For example, the temperature control unit 40 may be a thermoelectric device, a thermoacoustic device, or a heat exchanger for warm and cool water. In these embodiments, the thermoelectric device and the thermoacoustic device are economical temperature control units 40 because they do not need to use cool water or warm water, and are, thus, eco-friendly and cost-saving devices.

The temperature control unit 40 in these embodiments heat or cools the active material in advance so that the active material that is ejected through the coating unit 60 has a predetermined temperature. In the active material-coating apparatus according to the current embodiment, the temperature control unit 40 is located prior to a valve 50 and the coating unit 60 in the flow path of the active material, so that the active material to be coated onto the current collector 1 has an appropriate temperature for coating, and the process minimizes heat loss.

The active material that is heated and cooled by the temperature control unit 40 may have a first temperature. In the embodiment shown in FIGS. 1 and 2, although it is a short distance, the active material having the first temperature may experience heat loss during its flow path through the valve 50 and the first supply tube 51 toward the coating unit 60. Therefore, to prevent heat loss, in this embodiment, the first temperature may be set higher than the temperature (hereinafter, a “second temperature”) of the active material that is supplied to and ejected from the coating unit 60. For example, in one embodiment, the first temperature may be higher than the second temperature by approximately 3-4° C.

In an embodiment where the temperature of the active material that flows into the temperature control unit 40 is lower than the first temperature, the temperature control unit 40 heats the active material to the appropriate temperature. And in an embodiment where the temperature of the active material that flows into the temperature control unit 40 is higher than the first temperature, the temperature control unit 40 cools the active material to the appropriate temperature.

In the embodiment shown in FIG. 1, the active material, having a predetermined temperature set by the temperature control unit 40, is supplied to the coating unit 60 through the valve 50. The valve 50 may control the amount of the active material that flows into the coating unit 60. For example, the valve 50 may supply a portion of the active material to the coating unit 60 through the first supply tube 51 that connects the temperature control unit 40 to the coating unit 60, and the rest of the active material that is not supplied to the coating unit 60 may be returned back to the tank 10 through a second supply tube 52.

With reference now to the embodiment shown in FIG. 3 as well as FIGS. 1 and 2, the coating unit 60 includes an ejection unit 61 for coating the active material onto the current collector 1. In this embodiment, the active material is coated onto the current collector 1 by the ejection unit 61, and the heat insulating unit 70 may be located to maintain a constant temperature of the active material ejected from the ejection unit 61.

In the embodiment shown in FIG. 1, the heat insulating unit 70 may surround the coating unit 60 with the ejection unit 61 at its center. Through the heat insulating unit 70 in this embodiment, the active material, having the first temperature via heating or cooling at the temperature control unit 40, maintains a constant temperature (the second temperature) until immediately before being ejected through the ejection unit 61. For example, in an embodiment, the secondary temperature may range from about 30° C. to about 50° C., and in another embodiment, the secondary temperature may range from about 35° C. to about 45° C.

The control unit 100 controls the temperature control unit 40, the valve 50, and the heat insulating unit 70 such that the temperature, i.e., the second temperature, of the active material that is ejected through the ejection unit 61 is in a specified range, from about 30° C. to about 50° C., and in one embodiment, or in a specified range from about 35° C. to about 45° C., in another embodiment.

The control unit 100 may control the temperature of the temperature control unit 40 through inlet and outlet temperature sensors 91 and 92, respectively located on sides of the inlet 42a and the outlet 42b of the temperature control unit 40. For example, the control unit 100 may control the degree of heating or cooling of the temperature control unit 40 by sensing a temperature differential between the inlet temperature sensor 91 located on the inlet 42a side and the outlet temperature sensor 92 located on the outlet 42b side of the temperature control unit 40.

For example, in an embodiment where the temperature control unit 40 is a thermoelectric device, the control unit 100 may control the temperature control unit 40 by controlling the direction of current that is supplied to the thermoelectric device (i.e., the temperature control unit 40). In another embodiment where the temperature control unit 40 is a thermoacoustic device, the control unit 100 may control the temperature control unit 40 by controlling the direction of a thermoacoustic wave entering the thermoacoustic device (i.e., temperature control unit 40). Alternatively, in an embodiment where the temperature control unit 40 is a heat exchanger for warm water and cool water, the control unit 100 may control the temperature control unit 40 by controlling the amount, temperature, and velocity of the warm water or cool water that enters the heat exchanger (i.e., temperature control unit 40).

In embodiments where the temperature control unit 40 is a thermoelectric device or a thermoacoustic device, the control unit 100 may need to control only the directions of the current or thermoacoustic wave, respectively. Thus, the control unit 100 more easily controls the temperature control unit 40 in these embodiments where the temperature control unit 40 is a thermoelectric device or a thermoacoustic device than when the temperature control unit 40 includes other devices.

As described above, the temperature control unit 40, the heat insulating unit 70, and the control unit 100 of the active material-coating apparatus according to the current embodiment are operated such that the temperature of the active material ejected from the ejection unit 61 ranges from about 30° C. to about 50° C. And, in an embodiment, such that the temperature of the active material ranges from about 35° C. to about 45° C. The second temperature, i.e., the temperature of the active material that is ejected through the ejection unit 61, will be described in further detail below.

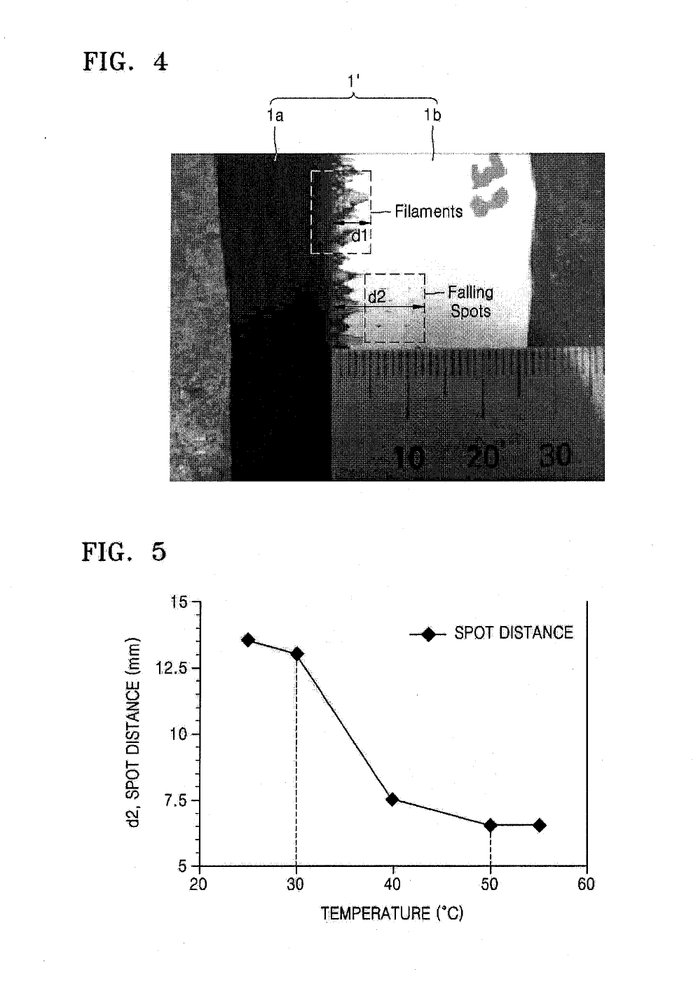

FIG. 3 is an expanded perspective view of the coating unit and the reel of FIG. 1. FIG. 4 is a photo image showing an example of an active material coated onto the current collector 1 according to an embodiment of the present invention. FIG. 5 is a graph illustrating the correlation between distances of falling-spots generated from a coating region of a coated current collector (i.e., an electrode plate) as the temperature of the active material is increased. In FIG. 5, d2 denotes a distance of the falling-spot, and is the longest distance measured from a boundary between a coating region 1a and a non-coating region 1b of the electrode plate 1′. In FIG. 3, for convenience of explanation, the heat insulating unit 70 is omitted from the drawing.

Referring to the embodiment shown in FIG. 3, the coating unit 60 includes the ejection unit 61 having a slit shape. The active material ejected from the ejection unit 61 in this embodiment is coated onto the current collector 1 that is supplied by the reel 80. A length of the ejection unit 61 in a first direction D1 may be less than a width of the reel 80 in the D1 direction, and may be less than a width of the current collector 1 in the D1 direction. Accordingly, the active material ejected from the ejection unit 61 according to this embodiment is coated onto a region on the current collector 1, forming the coating region 1a of the electrode plate. In this embodiment, a remaining region of the current collector 1 on which no active material is coated forms the non-coating region 1b of the electrode plate 1′.

Referring to the embodiment shown in FIG. 4, contingent upon the coating of the active material, the coating region 1a and the non-coating region 1b are formed on the electrode plate 1′, forming a boundary between the coating region 1a and the non-coating region 1b of the electrode plate 1′. Ideally, the boundary between the coating region 1a and the non-coating region 1b of the electrode plate 1′ may be clear. However, according to the temperature of the active material coated onto the current collector 1, i.e., the second temperature of the active material that is ejected from the ejection unit 61, a filament phenomenon and a falling-spot phenomenon, which cause an unclear boundary, may occur. The filament phenomenon occurs when the active material spreads towards the non-coating region 1b from the boundary between the coating region 1a and the non-coating region 1b of the electrode plate 1′. The falling-spot phenomenon occurs when the active material coats part of the non-coating region 1b of the electrode plate 1′ in a dotted or spotted manner. Both the filament phenomenon and the falling-spot phenomenon are related to a ratio of viscoelasticity, which is a ratio between viscosity and elasticity of the active material, and are affected by the temperature, i.e., the second temperature of the active material ejected from the ejection unit 61.

The embodiment shown in FIG. 5 is a graph showing the distances d2 of the falling-spots and d1 of the filaments (shown in FIG. 4) according to the in correlation with the temperature of the active material.

As illustrated in the embodiment shown in FIG. 5, as the second temperature is increased, the distance d2 of the falling-spots is reduced. In particular, in the embodiment where the second temperature is in a range from about 30° C. to about 50° C., the distance d2 of the falling-spots is greatly reduced. As shown in the embodiment of FIG. 5, when the second temperature is below 30° C., the distance d2 of the falling-spots greatly increases, but when the second temperature is greater than 50° C., the distance d2 of the falling-spots is not reduced. The reduction of the distance d2 of the falling-spots results in a reduction in that the distance d1 (refer to FIG. 4) of the filaments, and the reductions of the distances d1 and d2 of the filaments and the falling-spots, respectively, denotes an improvement in the quality of the electrode plate 1′. Also, since the distances d1 and d2 of the filament and the falling-spots are minimized in these embodiments, the coating speed of the active material may be increased.

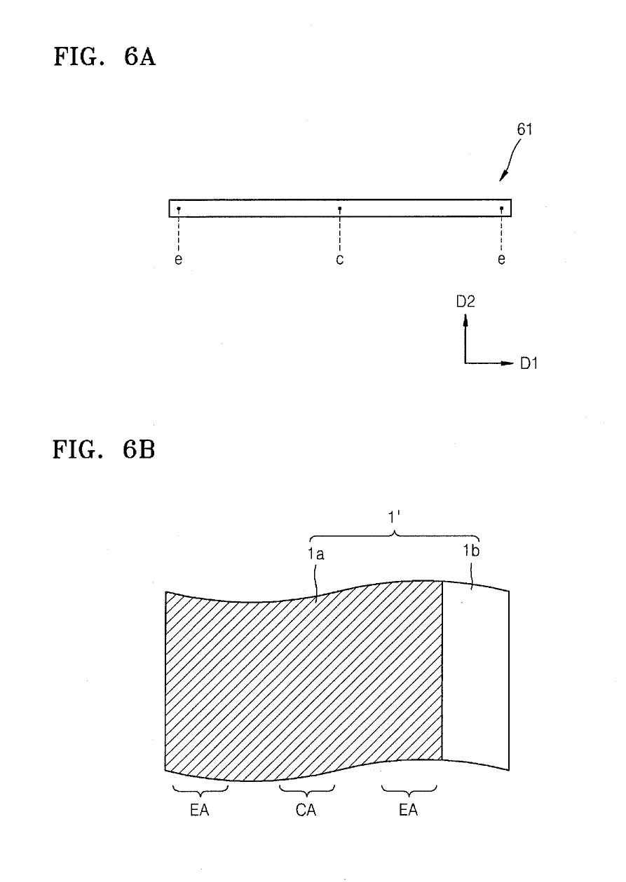

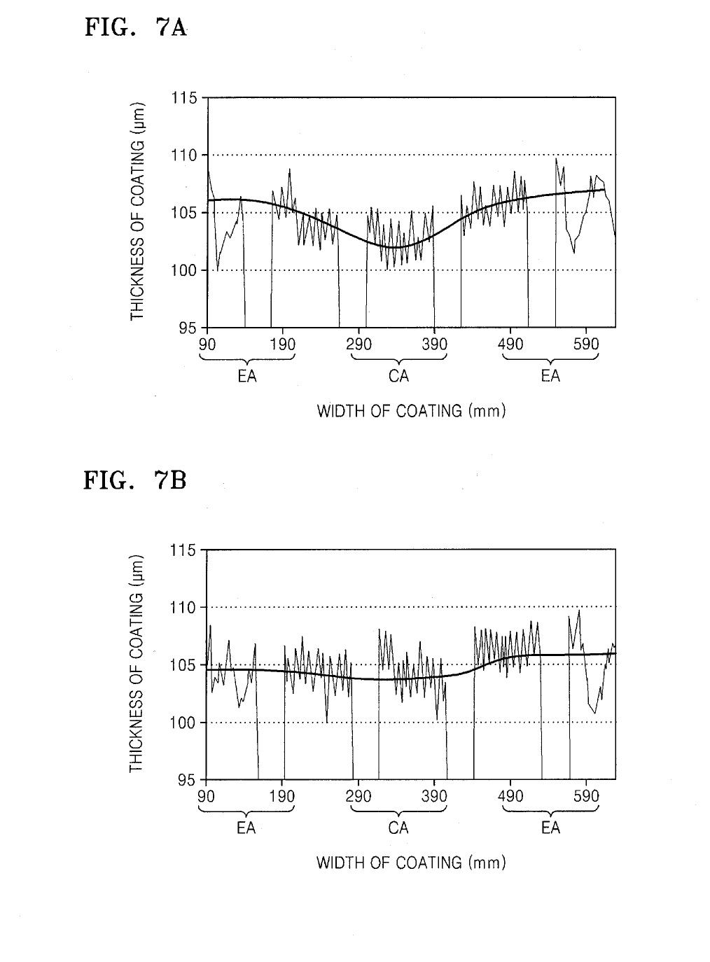

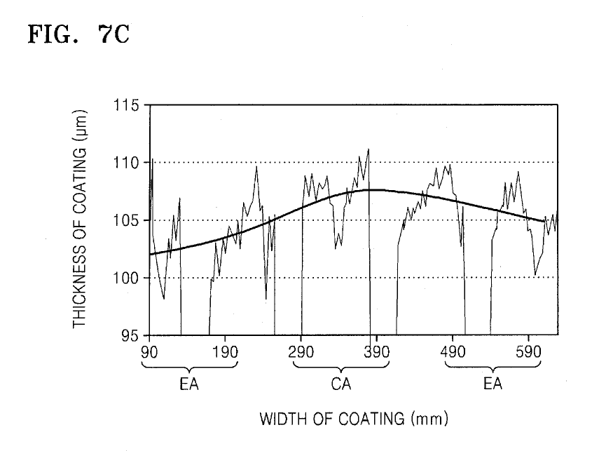

As described with reference to the embodiment above, in order to manufacture a high-quality electrode plate 1′, the temperature of the active material ejected through the ejection unit 61 may be in a range from about 30° C. to about 50° C. More specifically, in an embodiment where the uniformity of thickness of the active material coated onto the current collector 1 is considered, the temperature of the active material ejected through the ejection unit 61 may be in a range from about 35° C. to about 45° C. The temperature of the active material ejected through the ejection unit 61 will now be described in greater detail with reference to FIGS. 6A through 7C, below.

FIG. 6A is a schematic plan view of the ejection unit formed on the coating unit according to an embodiment of the present invention. FIG. 6B is a schematic elevation view of an upper surface of the electrode plate on which the active material ejected through the ejection unit of 6A is coated, according to an embodiment of the present invention. FIGS. 7A through 7C are graphs illustrating the thicknesses of the active material coated onto the current collector using the coating unit and the reel shown in FIG. 3 compared with a width of the current collector along a length direction of a slot.

Referring to the embodiment shown in FIG. 6A, the ejection unit 61 of the coating unit 60 has a slit shape in which the ejection unit 61 extends towards edges e from center c, thereof. As described above with reference to the embodiment shown in FIG. 3, the active material ejected from the ejection unit 61 having a slit shape is coated onto the current collector 1, and forms the coating region 1a and the non-coating region 1b of the electrode plate 1′. In this embodiment, the active material ejected from the center c of the ejection unit 61 is coated onto a central region CA of the coating region la, as shown in FIG. 6B, and the active material ejected from the edges e of the ejection unit 61 is coated onto edge regions EA of the coating region 1a, as shown in FIG. 6B. The thicknesses of the active material in each of the regions EA and CA of the coating region 1a according to embodiments of the present invention are described below.

Referring to the embodiment shown in FIG. 7A, when the second temperature of the active material is about 30° C., the thickness of the coating in the central region CA is less than that of the edge regions EA of the coating region 1a. Referring to the embodiment shown in FIG. 7C, when the second temperature of the active material is about 50° C., the thickness of the coating in the central region CA is greater than that of the edge regions EA of the coating region 1a. However, when the second temperature of the active material is approximately 40° C., as shown in the embodiment of FIG. 7B, the deviation of the thicknesses of the coatings between the coating in the central region CA and that in the edge regions EA is approximately 2-3 micrometer (μm). In this embodiment, the thickness distribution of the coating along the width of the current collector 1 is changes according to the temperature of the active material, as a result of a shear thinning characteristic of the active material, such that the flow of the active material is related to its shear rate and viscosity.

The occurrence of filaments and falling-spots in the active material-coating apparatus according to the current embodiment may be minimized by controlling the temperature of the active material ejected through the ejection unit 61 to fall within a range from about 30° C. to about 50° C. More specifically, the active material-coating apparatus according to another embodiment may minimize the occurrence of filaments and falling-spots, as well as may ensure thickness uniformity of the active material coating by controlling the temperature of the active material ejected through the ejection unit 61 to fall within a range from about 35° C. to about 45° C. In this embodiment, deviation of a loading level, i.e., deviation of the amount of the active material loaded on the current collector 1, may be minimized.

It should be understood that the exemplary embodiments described herein should be considered in a descriptive sense only and not for purposes of limitation. Descriptions of features or aspects within each embodiment should typically be considered available for other similar features or aspects in other embodiments.

What is claimed is:

1. An active material-coating apparatus for a secondary battery, the active material-coating apparatus comprising:
a tank comprising an active material;
a pump coupled to the tank such that the active material is routed through the pump;
a temperature control unit coupled to the pump, the temperature control unit configured to control heating or cooling of a temperature of the active material routed through the pump and comprising a control unit, the control unit configured to control a temperature of the temperature control unit;
a coating unit coupled to the temperature control unit; and
a reel comprising a current collector, wherein the reel is configured to route the current collector through the coating unit such that the current collector is coated with the active material routed through the temperature control unit end ejected from the coating unit.

2. The active material-coating apparatus of claim 1, wherein the coating unit further comprises a heat insulating unit and an ejection unit, wherein the heat insulating unit is configured to maintain the temperature of the active material that is ejected coated through the ejection unit at a constant temperature.

3. The active material-coating apparatus of claim 2, wherein the control unit is configured to control the temperature control unit and the heat insulating unit such that the temperature of the active material heated or cooled by the temperature control unit is greater than a constant temperature of the active material that is maintained by the heat insulating unit.

4. The active material-coating apparatus of claim 1, wherein the control unit is configured to control the temperature control unit such that the active material ejected through the coating unit is maintained at a temperature from about 30° C. to about 50° C.

5. The active material-coating apparatus of claim 4, wherein the active material ejected through the coating unit is able to be maintained at a temperature in a range from about 35° C. to about 45° C.

6. The active material-coating apparatus of claim 1, wherein the temperature control unit comprises an inlet and an outlet, and wherein the control unit comprises inlet and outlet temperature sensors provided on the inlet and the outlet of the temperature control unit, respectively, is configured to control the temperature control unit based on the temperatures measured by the inlet and outlet temperature sensors.

7. The active material-coating apparatus of claim 1, further comprising a valve that coupled between the temperature control unit and the coating unit, the valve configured to control the active material routed to the coating unit.

8. The active material-coating apparatus of claim 7, wherein the valve comprises a first supply tube coupling the valve with the coating unit such that the valve can supply a portion of the active material to the coating unit through the first supply tube, and
wherein the valve further comprises a second supply tube coupling the valve with the tank such that the valve can supply a remaining portion of the active material not supplied to the coating unit to the tank through the second supply tube.

9. The active material-coating apparatus of claim 1, wherein the coating unit comprises an ejection unit having a slit shape.

10. The active material-coating apparatus of claim 9, wherein a length of the ejection unit is smaller than a width of the reel such that the active material is coated onto a region of the current collector routed by the reel.

11. The active material-coating apparatus of claim 9, further comprising a heat insulating unit surrounding the coating unit and centered around the ejection unit.

12. The active material-coating apparatus of claim 1, further comprising a filter coupled between the pump and the temperature control unit, and configured to remove impurities in the active material.

13. The active material-coating apparatus of claim 1, wherein the temperature control unit is a thermoelectric device, and the control unit is configured to control heating or cooling of the temperature control unit by controlling a current that is supplied to the thermoelectric device.

14. The active material-coating apparatus of claim 1, wherein the temperature control unit is a thermoacoustic device, and the control unit is configured to control heating or cooling of the temperature control unit by controlling a thermoacoustic wave.

15. The active material-coating apparatus of claim 1, wherein the temperature control unit is a heat exchanger for warm water and cool water, and the control unit is configured to control heating or cooling of the temperature control unit by controlling a flow of warm water or cool water into the heat exchanger.

16. A method of operating an active material-coating apparatus, the method comprising:
supplying an active material stored in a tank to a temperature control unit through a pump;
controlling a temperature of the active material supplied to the temperature control unit by cooling or heating the active material using the temperature control unit to a first temperature;
supplying the active material at the first temperature from the temperature control unit to a coating unit;
maintaining the active material at a constant temperature using a heat insulating unit surrounding the coating unit such that the active material ejected through the coating unit has a second temperature; and
coating the active material having the second temperature onto an electrode assembly supplied through the coating unit, wherein the first temperature is higher than the second temperature.

17. The method of claim 16, wherein the second temperature is maintained constant from about 30° C. to about 50° C.

18. The method of claim 16, wherein the temperature control unit comprises an inlet and an outlet, and controlling the temperature of the active material comprises determining cooling or heating of the temperature control unit based on a temperature measured at the inlet of the temperature control unit and a temperature measured at the outlet of the temperature control unit.

19. The method of claim 16, wherein supplying the active material to the coating unit further comprises:
supplying a portion of the active material to the coating unit; and
supplying the remaining portion of the active material not supplied to the coating unit back to the tank.

20. The method of claim 16, further comprising removing impurities in the active material using a filter.
